(19) United States
(12) Patent Application Publication
(10) Pub. No.: US 2026/0148130 A1
(43) Pub. Date: May 28, 2026

(54) AUTOMATED SELECTION AND DEPLOYMENT OF MACHINE LEARNING MODEL INSTANCES TO TARGET COMPUTING DEVICES

(71) Applicant: Dell Products LP, Round Rock, TX (US)

(72) Inventors: Shaul Dar, Petach Tikva (IL); Itzik Reich, Kefar Saba (IL)

(21) Appl. No.: 18/961,692

(22) Filed: Nov. 27, 2024

(51) Int. Cl. G06N 20/00

(52) U.S. Cl. CPC G06N 20/00

(57) ABSTRACT

An apparatus comprises at least one processing device configured to determine a machine learning model type to be deployed on a target computing device, to identify machine learning model performance metrics for operating the determined machine learning model type on the target computing device, and to determine whether any available instances of the determined machine learning model type (i) have hardware requirements compatible with a hardware configuration of the target computing device and (ii) meet the identified machine learning model performance metrics. The at least one processing device is also configured, responsive to determining that at least a subset of the available instances meet (i) and (ii), to select a given machine learning model instance of the determined machine learning model type from the subset of the available instances of the determined machine learning model type, and to deploy the given machine learning model instance to the target computing device.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). AI and ML may be used for various tasks, including content creation, code generation and natural language processing (NLP) including text classification, text summarization, text generation, named entity recognition, text sentiment analysis, and question answering.

### SUMMARY

Illustrative embodiments of the present disclosure provide techniques for automated selection and deployment of machine learning model instances to target computing devices.

In one embodiment, an apparatus comprises at least one processing device comprising a processor coupled to a memory. The at least one processing device is configured to determine a machine learning model type to be deployed on a target computing device, to identify machine learning model performance metrics for operating the determined machine learning model type on the target computing device, and to determine whether any of a set of one or more available instances of the determined machine learning model type (i) have hardware requirements compatible with a hardware configuration of the target computing device and (ii) meet the identified machine learning model performance metrics for operating the determined machine learning model type on the target computing device. The at least one processing device is also configured, responsive to determining that at least a subset of the set of one or more available instances of the determined machine learning model type (i) have hardware requirements compatible with the hardware configuration of the target computing device and (ii) meet the identified machine learning model performance metrics for operating the determined machine learning model type on the target computing device, to select a given machine learning model instance of the determined machine learning model type from the subset of the set of one or more available instances of the determined machine learning model type. The at least one processing device is further configured to deploy the given machine learning model instance of the determined machine learning model type to the target computing device.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for automated selection and deployment of machine learning model instances to target computing devices in an illustrative embodiment.

FIG. 2 is a flow diagram of an exemplary process for automated selection and deployment of machine learning model instances to target computing devices in an illustrative embodiment.

FIG. 3 shows a portfolio of artificial intelligence and machine learning solutions in an illustrative embodiment.

FIG. 4 shows a process flow for artificial intelligence and machine learning model mobility across platforms in an illustrative embodiment.

FIG. 5 shows a table characterizing different versions of a large language model in an illustrative embodiment.

FIG. 6 shows an example of quantization of an artificial intelligence or machine learning model in an illustrative embodiment.

FIG. 7 shows a plot of cross-entropy loss as a function of model size for different versions of an artificial intelligence or machine learning model in an illustrative embodiment.

FIG. 8 shows a knowledge distillation teacher-student architecture in an illustrative embodiment.

FIG. 9 shows a graph of artificial intelligence or machine learning model inference speed for models with different complexities in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

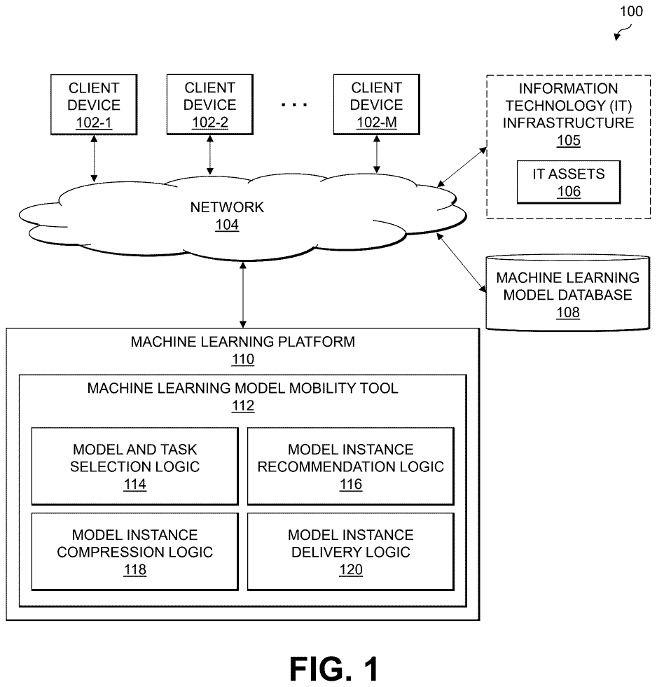

FIG. 1 shows an information processing system 100 configured in accordance with an illustrative embodiment. The information processing system 100 is assumed to be built on at least one processing platform and provides functionality for automated selection and deployment of machine learning model instances to target computing devices. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a machine learning model database 108, and a machine learning platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the machine learning platform 110 is used for an enterprise system. For example, an enterprise may provide, subscribe to or otherwise utilize the machine learning platform 110 for enabling machine learning model mobility across platforms (e.g., different ones of the client devices 102 and/or IT assets 106 of the IT infrastructure 105) utilizing a machine learning model mobility tool 112. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The machine learning model database 108 is configured to store and record various information that is utilized by the machine learning platform 110. Such information may include, for example, one or more repositories of machine learning models, including families of machine learning models which have different sizes (e.g., numbers of parameters), task-to-model mappings, mapping tasks to be performed to suitable machine learning models (e.g., including to types or families of machine learning model which have different sizes), compressed versions of machine learning models, statistics or other analysis relating to performance of machine learning models on different hardware platforms, etc. The machine learning model database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the machine learning platform 110, as well as to support communication between the machine learning platform 110 and other related systems and devices not explicitly shown.

The machine learning platform 110 may be provided as a cloud service that is accessible by one or more of the client devices 102 to allow users thereof to manage “mobility” or deployment of machine learning models to different target platforms (e.g., different ones of the client devices 102 and/or IT assets 106 which have different hardware and/or software configurations). In some embodiments, the client devices 102 are assumed to be associated with users of an enterprise, organization or other entity that seeks to determine or identify a suitable machine learning model to use for achieving one or more tasks. In some embodiments, the client devices 102 are utilized by members of the same enterprise, organization or other entity that operates the machine learning platform 110. In other embodiments, the client devices 102 are utilized by members of one or more enterprises, organizations or other entities different than the enterprise, organization or other entity that operates the machine learning platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the machine learning model database 108 and the machine learning platform 110 regarding tasks to be performed, preferences for machine learning models (e.g., inference speed, accuracy, model size), machine learning model instances downloaded to the client devices 102 and/or the IT assets 106, etc. It should be noted that a “host agent” as this term is generally used herein may comprise an automated entity, such as a software entity running on a processing device. Accordingly, a host agent need not be a human entity.

The machine learning platform 110 in the FIG. 1 embodiment is assumed to be implemented using at least one processing device. Each such processing device generally comprises at least one processor and an associated memory, and implements one or more functional modules or logic for controlling certain features of the machine learning platform 110. In the FIG. 1 embodiment, the machine learning platform 110 implements the machine learning model mobility tool 112. The machine learning model mobility tool 112 comprises model and task selection logic 114, model instance recommendation logic 116, model instance compression logic 118, and model instance delivery logic 120. The model and task selection logic 114 is configured to receive specification of an artificial intelligence (AI) or machine learning (ML) task to be performed, or selection of a specific type of AI/ML model that is to be deployed to a target platform (e.g., one or more of the client devices 102 and/or one or more of the IT assets 106). The model instance recommendation logic 116 is configured to analyze the target platform (e.g., a hardware and software configuration thereof) and user preferences (e.g., relating to model size, accuracy, inference speed, etc.) to determine suitable AI/ML model instances for the specified AI/ML model type and/or for performing the specified AI/ML task. The model instance recommendation logic 116 may be configured to determine whether there are any suitable or qualifying AI/ML model instances available (e.g., in the machine learning model database 108 or other repository or source of AI/ML model instances) given the target platform and user preferences. If so, one of the suitable or qualifying AI/ML model instances may be automatically deployed to the target platform utilizing the model instance delivery logic 120. If there are no suitable or qualifying AI/ML model instances available, then the model instance compression logic 118 may generate a compressed AI/ML model instance which meets the requirements of the target platform and the user preferences. To do so, the model instance compression logic 118 may perform quantization, knowledge distillation or other techniques for producing an AI/ML model instance with a smaller model size (e.g., that is suitable given the available hardware resources of the target platform). The model instance delivery logic 120 will then deploy the compressed AI/ML instance to the target platform.

At least portions of the machine learning model mobility tool 112, the model and task selection logic 114, the model instance recommendation logic 116, the model instance compression logic 118, and the model instance delivery logic 120 may be implemented at least in part in the form of software that is stored in memory and executed by a processor.

It is to be appreciated that the particular arrangement of the client devices 102, the IT infrastructure 105, the machine learning model database 108 and the machine learning platform 110 illustrated in the FIG. 1 embodiment is presented by way of example only, and alternative arrangements can be used in other embodiments. As discussed above, for example, the machine learning platform 110 (or portions of components thereof, such as one or more of the machine learning model mobility tool 112, the model and task selection logic 114, the model instance recommendation logic 116, the model instance compression logic 118, and the model instance delivery logic 120) may in some embodiments be implemented internal to the IT infrastructure 105.

The machine learning platform 110 and other portions of the information processing system 100, as will be described in further detail below, may be part of cloud infrastructure.

The machine learning platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the machine learning model database 108 and the machine learning platform 110 or components thereof (e.g., the machine learning model mobility tool 112, the model and task selection logic 114, the model instance recommendation logic 116, the model instance compression logic 118, and the model instance delivery logic 120) may be implemented on respective distinct processing platforms, although numerous other arrangements are possible. For example, in some embodiments at least portions of the machine learning platform 110 and one or more of the client devices 102, the IT infrastructure 105, the IT assets 106 and/or the machine learning model database 108 are implemented on the same processing platform. A given client device (e.g., 102-1) can therefore be implemented at least in part within at least one processing platform that implements at least a portion of the machine learning platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the machine learning model database 108 and the machine learning platform 110, or portions or components thereof, to reside in different data centers. Numerous other distributed implementations are possible. The machine learning platform 110 can also be implemented in a distributed manner across multiple data centers.

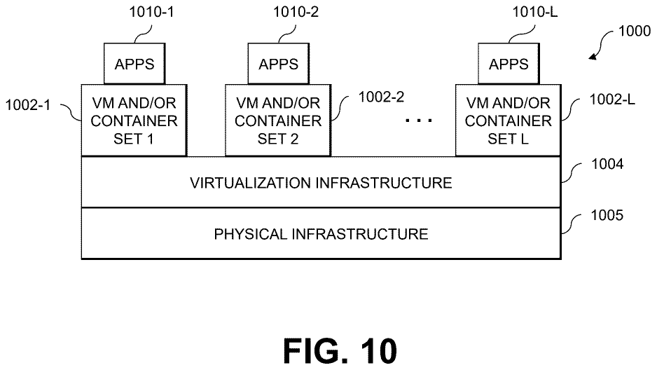

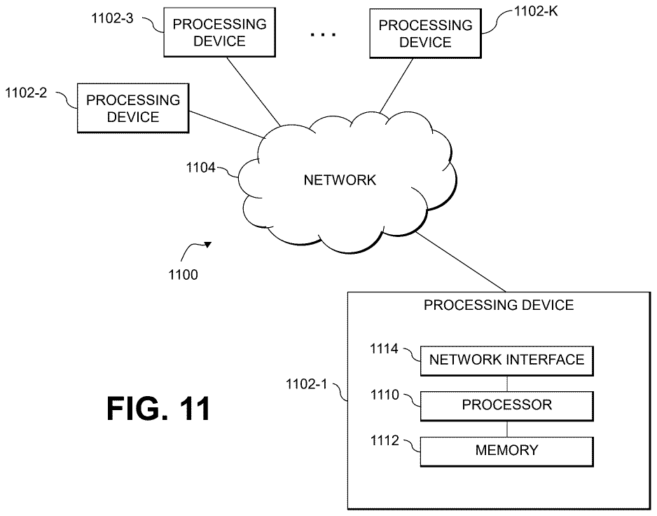

Additional examples of processing platforms utilized to implement the machine learning platform 110 and other components of the information processing system 100 in illustrative embodiments will be described in more detail below in conjunction with FIGS. 10 and 11.

It is to be understood that the particular set of elements shown in FIG. 1 for automated selection and deployment of machine learning model instances to target computing devices is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

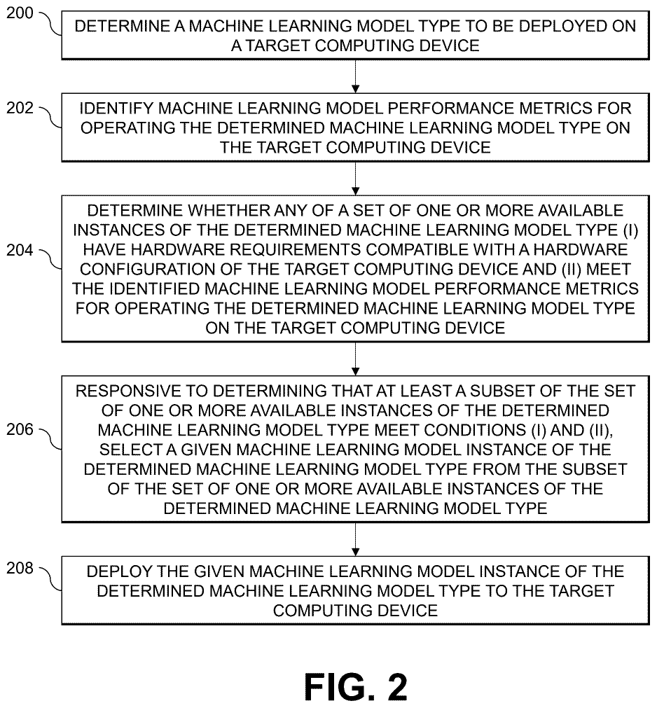

An exemplary process for automated selection and deployment of machine learning model instances to target computing devices will now be described in more detail with reference to the flow diagram of FIG. 2. It is to be understood that this particular process is only an example, and that additional or alternative processes for automated selection and deployment of machine learning model instances to target computing devices may be used in other embodiments.

In this embodiment, the process includes steps 200 through 208. These steps are assumed to be performed by the machine learning platform 110 utilizing the machine learning model mobility tool 112, the model and task selection logic 114, the model instance recommendation logic 116, the model instance compression logic 118, and the model instance delivery logic 120. The process begins with step 200, determining a machine learning model type to be deployed on a target computing device. Step 200 may include receiving a specification of the determined machine learning model type from a user associated with the target computing device. Step 200 may alternatively include receiving a specification of one or more machine learning tasks to be performed, and generating a mapping of the one or more machine learning tasks to the determined machine learning model type. Step 200 may further include selecting one or more repositories of machine learning model instances storing available instances of the determined machine learning model type. The determined machine learning model type may comprise a group or family of two or more versions of a same machine learning model, where the two or more versions of the same machine learning model may utilize different numbers of parameters.

In step 202, machine learning model performance metrics for operating the determined machine learning model type on the target computing device are identified. The machine learning model performance metrics may comprise one or more model size constraints, a machine learning model accuracy, a machine learning model inference speed, etc.

In step 204, a determination is made as to whether any of a set of one or more available instances of the determined machine learning model type (i) have hardware requirements compatible with a hardware configuration of the target computing device and (ii) meet the identified machine learning model performance metrics for operating the determined machine learning model type on the target computing device. In step 206, responsive to determining that at least a subset of the set of one or more available instances of the determined machine learning model type (i) have hardware requirements compatible with the hardware configuration of the target computing device and (ii) meet the identified machine learning model performance metrics for operating the determined machine learning model type on the target computing device, a given machine learning model instance of the determined machine learning model type is selected from the subset of the set of one or more available instances of the determined machine learning model type. In step 208, the given machine learning model instance of the determined machine learning model type is deployed to the target computing device.

The FIG. 2 process may further include, responsive to determining that none of the set of one or more available instances of the determined machine learning model type (i) have hardware requirements compatible with the hardware configuration of the target computing device and (ii) meet the identified machine learning model performance metrics for operating the determined machine learning model type on the target computing device: generating a compressed machine learning model instance of the determined machine learning model type; and deploying the generated compressed machine learning model instance of the determined machine learning model type to the target computing device.

In some embodiments, generating the compressed machine learning model instance of the determined machine learning model type may comprise performing quantization of at least a portion of one of the set of one or more available instances of the determined machine learning model type from a first precision to a second precision, the second precision being lower than the first precision. The first precision may be a floating point precision with a first number of bits and the second precision may be a floating point precision with a second number of bits or an integer precision with the second number of bits, the second number of bits being less than the first number of bits. In some embodiments, generating the compressed machine learning model instance of the determined machine learning model type comprises performing a variable quantization of two or more portions of one of the set of one or more available instances of the determined machine learning model type between different precision levels. In some embodiments, generating the compressed machine learning model instance of the determined machine learning model type may also or alternatively include performing knowledge distillation of at least a portion of one of the set of one or more available instances of the determined machine learning model type utilizing a teacher-student knowledge distillation architecture.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

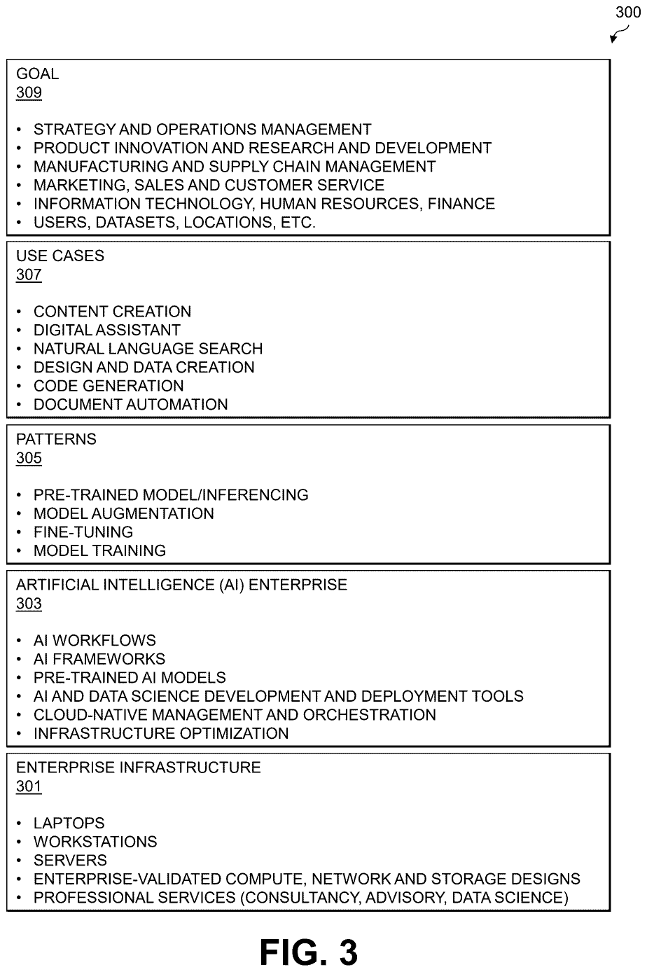

An enterprise, organization or other entity may have a massive portfolio of existing and upcoming capabilities for AI/ML models and workloads, across a range of platforms. FIG. 3, for example, shows a portfolio 300 of AI/ML solutions which may be offered by an enterprise. The enterprise may offer or prove various infrastructure solutions, including laptops, workstations, servers, enterprise-validated compute, network and storage designs (e.g., including edge computing designs), professional services (e.g., consultancy, advisory, data science, etc.), etc. The enterprise infrastructure 301 may be powered by graphics processing units (GPUs) of one or more vendors (e.g., NVIDIA GPUs). These or other vendors may provide an AI enterprise 303 providing AI workflows, AI frameworks, pre-trained AI/ML models, AI and data science development and deployment tools, cloud-native management/orchestration, infrastructure optimization, etc. Various AI/ML patterns 305, including pre-trained AI/ML models and inferencing, AI/ML model augmentation, fine-tuning of AI/ML models, AI/ML model training, etc. may be provided and run on the enterprise infrastructure 301 utilizing offerings of the AI enterprise 303. AI/ML use cases 307 include content creation, digital assistants, natural language search, design and data creation, code generation, document automation, etc. These AI/ML use cases 307 may be used for various enterprise goals 309, including: strategy and operations management; product innovation and research and development (R&D); manufacturing and supply chain management; marketing, sales and customer service; IT, human resources (HR) and finance; users; datasets; locations; etc. In conventional approaches, however, capabilities for such AI/ML models and workloads are siloed, and AI/ML models and workloads are not allowed to move between platforms (e.g., from servers to laptops) and do not support AI/ML model sizing to fit target platforms.

The technical solutions described herein provide functionality for AI/ML model mobility and optimization across different platforms, from client to server and storage, from cloud to on-premises/edge and vice-versa, etc. Such functionality may be referred to as “AI Everywhere.” The AI Everywhere functionality provides an innovative connecting tissue to support AI/ML model mobility and optimization. The technical solutions can thus advantageously create a strong synergy between an enterprise's AI/ML offerings, and provide value for enabling an enterprise to be a one-stop shop for all AI/ML IT needs.

Consider, as an example, a large software development organization which purchases servers or cloud solutions from an enterprise. With the enterprise implementing AI Everywhere functionality, the software development organization will have a strong incentive to also purchase other platforms and solutions from the enterprise, such as laptops. This multiplier effect will work across all of the enterprise's portfolio and will grow stronger over time. The AI Everywhere functionality leverages emerging industry trends of consuming AI/ML models and applications from centralized portals (e.g., Hugging Face) as well as AI/ML models which are already packed in a container (e.g., an enterprise hub on Hugging Face, NVIDIA NIM™, etc.). The AI Everywhere functionality described herein extends these capabilities to enable AI/ML model mobility between different hardware platforms, while optimizing the AI/ML models for the hardware that is present on the target platforms.

In some embodiments, the AI Everywhere functionality goes beyond mobilizing the same AI/ML model between platforms. The AI Everywhere functionality is able to recommend to users the best choice from a family of similar AI/ML models to provide optimal performance according to the hardware of a target platform as well as user preferences, balancing model size, accuracy, inference speed and other desired metrics. Further, the AI Everywhere functionality is able to compress “large” AI/ML models to fit on “small” hardware, with minimal degradation in AI/ML model performance. For example, when downloading a large AI/ML model (e.g., a generative AI or GenAI model) trained on a cloud platform to a laptop or edge device, that AI/ML model may be compressed to fit on the target platform using techniques such as quantization, knowledge distillation, etc. The AI Everywhere functionality can also save the relationships between instantiations of the same AI/ML model (e.g., optimized for different hardware) and related performance results and other metadata, allowing users to compare and choose the best AI/ML model for their needs and constraints.

The AI Everywhere functionality described herein advantageously enables AI/ML models to be mobilized between different hardware platforms (e.g., including hardware platforms from the same or different enterprises and/or vendors). The AI Everywhere functionality is thus able to recommend the best AI/ML model from a given AI/ML model family to use on a target platform, taking into consideration AI/ML model attributes (e.g., a number of parameters, bits-per-weight, etc.), target hardware specifications (e.g., random-access memory (RAM)/virtual RAM (VRAM) size, central processing unit (CPU)/GPU models and specifications, etc.), and user preferences (e.g., model accuracy, inference speed, etc.). The AI Everywhere functionality is further able to compress a “large” AI/ML model to fit a smaller target, by analyzing and employing AI/ML model compaction or compression techniques, to reduce AI/ML model footprint (e.g., RAM, CPU/GPU, disk, etc.), accelerate inference time, and achieve minimal degradation in model performance, in accordance with user preferences. The AI Everywhere functionality may further be used to create an AI/ML model repository (e.g., an AI/ML model app store) linking different instantiations of the same AI/ML model using unique identifiers, allowing users to compare and choose the best AI/ML model for their needs and constraints. The advantages of the AI Everywhere functionality are shown through evaluation of actual use cases, using the Large Language Model Meta AI (Llama) family of autoregressive large language models (LLMs) as a basis for comparison of the different options that the AI Everywhere functionality can suggest.

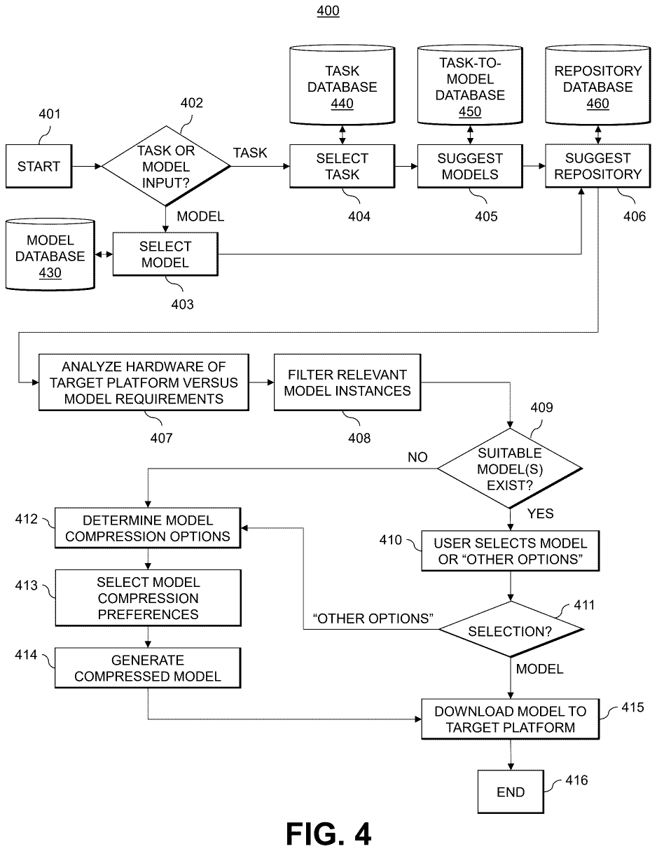

FIG. 4 shows a process flow 400 for implementing the AI Everywhere functionality (e.g., an AI Everywhere application), including main logic components, related databases and user actions. The process flow starts in block 401, where a user connects to the AI Everywhere application. In block 402, the user is asked if they want to perform an AI/ML task (e.g., machine translation, image generation, writing code, etc.), or if the user has a particular AI/ML model that they wish to use and deploy to a target platform. If the user selects “model” in block 402, the process flow 400 proceeds to block 403 where a particular AI/ML model is selected from a model database 430. If the user selects “task” in block 402, the process flow 400 proceeds to block 404 where the task is selected from a task database 440 (e.g., through a graphical user interface (GUI) of the AI Everywhere application, such as a top-down menu where the top level may be text/code/image/video/audio/data, etc., or a free form search). The AI Everywhere application in block 405 will then suggest AI/ML models for the selected task utilizing a task-to-model database 450 which maps between tasks and particular AI/ML models (or types of models, families of models, etc.). Thus, the AI Everywhere application will filter and suggest to the user relevant models that they can use for their desired task selected in block 404.

Following block 403 or block 405, the AI Everywhere application in block 406 suggests a repository from which the AI/ML model should be downloaded. Block 406 may utilize a repository database 460, which may be an open-source repository (e.g., Hugging Face), a containerized repository (e.g., an enterprise hub on Hugging Face, NVIDIA NIM, an AI/ML model store, etc.). The AI/ML model may be available in multiple incarnations (e.g., different versions and sizes), referred to as AI/ML model instances. The AI Everywhere application in block 407 will fetch the requirements of the different AI/ML model instances and analyze them with respect to the specifications of the target platform of the user (e.g., the user's laptop, edge device, etc.). In block 408, the AI Everywhere application will filter and display only “qualifying” AI/ML model instances (e.g., ones which are suitable for the hardware of the target platform and any specified user preferences).

In block 409, a determination is made as to whether any qualifying AI/ML model instances exist. If the result of block 409 is yes, the process flow 400 proceeds to block 410 where the user is asked to choose the qualifying AI/ML model instance that they want, or the user may select “other options.” In block 411, a determination is made as to whether the user selected a qualifying AI/ML model instance or other options. If the user selected other options in block 410 (e.g., the user wants to run a larger AI/ML model instance than the qualifying AI/ML model instances), or if no qualifying AI/ML model instance exists in block 409 (e.g., all the available AI/ML model instances are too large for the target platform), the process flow 400 proceeds to block 412 where model compression options are determined. In block 413, the user is prompted to select AI/ML model compression preferences. It should be noted that, in some cases, block 413 may be automated and the AI Everywhere application may automatically select AI/ML model compression options. In block 414, a compressed AI/ML model instance is generated according to the AI/ML model requirements, the hardware of the target platform and user preferences. If the user selected one of the qualifying AI/ML model instances in block 410, the process flow 400 following block 411 will download the selected qualifying AI/ML model instance to the target platform in block 415, and the process flow 400 ends in block 416. Otherwise, the compressed AI/ML model instance generated in block 411 will be downloaded to the target platform in block 415, and the process flow 400 ends in block 416.

In some cases, the AI Everywhere application may run on servers and utilize databases which run on a cloud computing platform (e.g., an enterprise cloud). Clients or users can run on any of the enterprise's (or certified third-party) equipment, such as servers, personal computers, edge devices, etc. The clients or users can connect to the AI Everywhere application via HyperText Transfer Protocol (HTTP) or another suitable protocol. It should further be noted that while various stages or blocks of the process flow 400 are described as being interactive (e.g., requiring user selection), this is not a requirement. In some embodiments, the entire process flow 400 may be fully automated using configuration files, for example, according to the policies of the relevant organization or department.

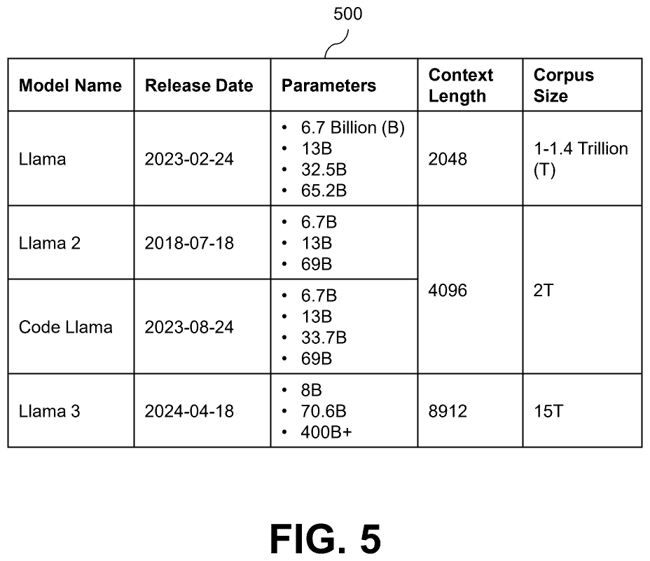

AI/ML model recommendation will now be described in further detail. Consider, for example, a user interested in running one of the Llama LLMs on their laptop. Llama is a family of autoregressive LLMs released by Meta AI starting in February 2023, with the Llama 3 version being released in April 2024. The Llama LLM model is available in multiple instances (e.g., versions and sizes), as shown in the table 500 of FIG. 5, which shows different model versions (Llama, Llama 2, Code Llama, Llama 3) and their associated release dates along with numbers of parameters, context length and corpus size. To select among these model instances, various constraints and criteria may be used. Often, the most important constraint is the model size, which may be determined approximately by multiplying the number of parameters and precision (e.g., bits per weight, bpw). The default precision is typically 16 bits=2 bytes. Consider, by way of example, the Llama 2 models which have respective sizes of approximately 13 gigabytes (GB) for 6.7 billion (B) parameters, 26 GB for 13 B parameters, and 140 GB for 70 B parameters. Thus, for a laptop with 16 GB RAM, the 6.7 B parameter Llama 2 model would be the only feasible choice. For a laptop with 32 GB of RAM (or VRAM), then the 13 B parameter Llama 2 model is also a feasible choice.

Another factor or parameter to consider is the CPU and/or GPU model and specifications of the target platform, and how they match up against the AI/ML model requirements. For example, the Microsoft Recall feature for Windows requires a Neural Processing Unit (NPU) with a minimum speed of 45 Teraflops (TFLOPs). Different NPUs provide different speeds, and thus may or may not be suitable for running the Microsoft Recall feature. For example, the Qualcomm Snapdragon X Elite NPU meets the 45 TFLOPs requirement, while other NPUs do not. The Apple M3 Neural Engine ships with 18 TFLOPs of AI performance, Intel's Meteor Lake NPU has 11 TFLOPs, The XDNA NPU in AMD's Ryzen 8040 has 16 TFLOPs, etc. As newer NPUs are developed and released, performance parameters will change but the general principle will remain that for large computationally heavy AI/ML models it is important to ensure that the hardware of the target platform can provide the required performance.

Techniques for compressing AI/ML model instances to reduce their memory footprint and accelerate their inference time (e.g., opening up additional options for AI/ML model instance selection and optimization) will now be described.

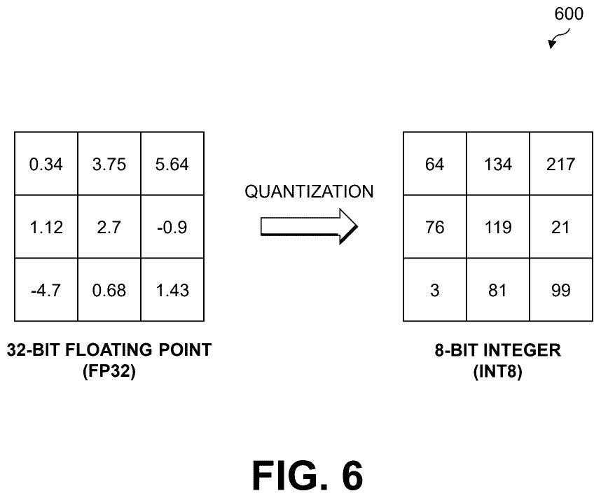

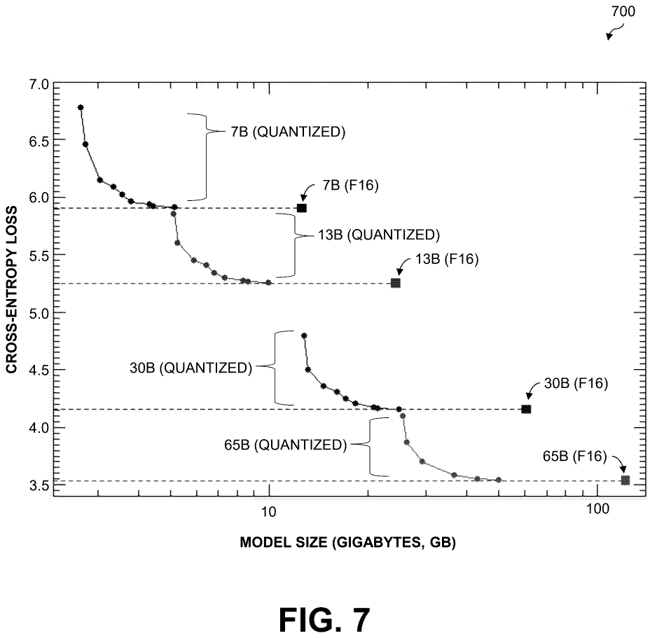

One approach for compressing AI/ML model instances is to apply quantization. Model quantization is a deep learning optimization method in which model data (e.g., both network parameters and activations) are converted from a first higher precision representation to a second lower precision representation (e.g., from 32-bit floating point or FP32 to a lower floating point of integer representation, such as 6-16 bits for floating point, 8-bit integer or INT8). FIG. 6 shows an example 600 of quantization of an AI/ML model from FP32 to INT8. Quantization is often applied to a model following the training process (e.g., Post-Training Quantization or PTQ), but can also be applied during the training process (e.g., Quantization-Aware Training or QAT). Reducing the number of bits means the resulting model requires less memory, consumes less energy (in theory), and operations like matrix multiplication can be performed much faster with integer arithmetic. It also makes it possible to run AI/ML models on embedded devices, which may support only integer data types. Various vendors offer quantization guides and open-source code libraries for their respective CPU and GPU architectures. Typically, the AI/ML model performance degradation resulting from quantizing from 16 bits down to 8 bits is pretty negligible. Going down to 4 bits does slightly degrade performance, but not as much as going down in the number of parameters (e.g., a 13 B parameter AI/ML model with 4 bits is generally still significantly better than a 7 B parameter AI/ML model at 16 bits). This is illustrated in the plot 700 shown in FIG. 7, which shows the cross-entropy loss (perplexity) for the Wikitext dataset as a function of model size for the Llama 2 model family. The model size axis in the plot 700 is logarithmic, and for the cross-entropy loss lower values are better. As a rule of thumb, 6 bit quantization is often ideal for model performance, while 4 bit quantization offers a good balance between size and performance. As a concrete example, a 2 bit quantization of the 30 B parameter Llama 2 model fits on a 16 GB NVIDIA GeForce RTX 4080 GPU, while other versions do not, resulting in a significant improvement in inference performance.

A quantization process, in some embodiments, utilizes quantization libraries such as the Hugging Face Quantization library. The Hugging Face Quantization library provides a wrapper enabling the specification of the desired data type and weight for model parameters (e.g., float8, int8, int4, int2, etc.) and activations (e.g., none, int8, float8, etc.). This library also allows listing modules to be excluded from quantization. The wrapper supports a variety of quantization methods with different capabilities and optimization techniques (e.g., bitsandbytes, Generalized Post-Training Quantization (GPTQ), Activation-aware Weight Quantization (AWQ), Additive Quantization of Language Models (AQLM), Quanto, Easy & Efficient Quantization for Transformers (EEQT), Half-Quadratic Quantization (HQQ), Facebook General Matrix Multiply FP8 (FPGEMM_FP8), Optimum, TorchAO, etc.). Some quantization methods are designed for specific hardware. For example, the Optimum library can be used for quantization of AI/ML models on Intel CPUs, Furiosa NPUs, or model accelerators like ONNX Runtime. The Optimum AMD library provides a Ryzen AI Quantizer user for AI/ML models running on AMD GPUs.

In some embodiments, variable-size quantization is used. The quantization technique does not have to choose a fixed number of bits for each parameter. For example, LLM quantization algorithms like picoLLM may take as input a task-specific cost function and automatically learn the optimal bit allocation strategy across and within an LLM's weights. Such variable-size quantization can significantly outperform other approaches like GPTQ. Methods such as GPT-Generated Unified Format (GGUF) and EXL2 may vary the bitrate across model layers. The AI Everywhere application may recommend to the user one or more quantization libraries and settings that fit the hardware of the target platform and user preferences, including projected model performance for each choice (e.g., presented as a tradeoff curve in the plot 700 of FIG. 7, but which may be simplified for user comprehension). The AI Everywhere application will then apply the selected quantization method and allow the user to download or otherwise obtain the quantized AI/ML model instance (e.g., a compressed AI/ML model instance).

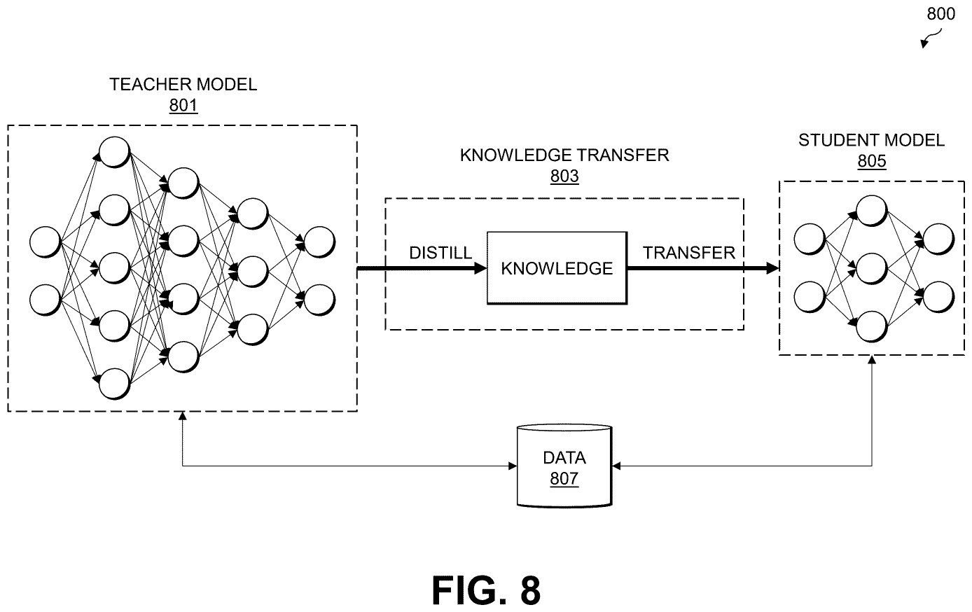

Another option for AI/ML model compression is applying knowledge distillation. Knowledge distillation is a training technique that trains small AI/ML models to be as accurate as larger AI/ML models by transferring knowledge. In the domain of knowledge distillation, the larger model is referred to as the teacher network or model, while the smaller model is referred to as the student network or model. FIG. 8 shows a knowledge distillation teacher-student architecture 800, including a teacher model 801, knowledge transfer 803, a student model 805 and data 807. In the simplest case, the student model 805 learns only from the outputs of the teacher model 801, treating the teacher model 801 as a “black box.” This is the only approach if the teacher model is closed source. The student model 805 may have improved performance if it can also learn from the internal features of the teacher model 801 (e.g., logits, hidden states, attention scores, etc.). As another variation, multiple teacher models can be combined.

Consider, for example, the Gemma 2 model released by Google. In addition to a full 27 B parameter version of Gemma 2, Google also released a 9 B parameter version created using knowledge distillation trained from the 27 B parameter version, and a 2 B parameter version trained from the Gemma 1 7 B parameter model version (e.g., keeping a size ratio of approximately 3:1 between teacher and student models), instead of next token prediction. The distilled models performed significantly better than their from-scratch counterparts, and had consistently lower perplexity scores. In addition, the distilled models retained user satisfaction (e.g., 96%) in human evaluations.

Another example is the Baby Llama project, trained on an ensemble including a GPT-2 and small Llama models on the developmentally plausible 10 million (M) word BabyLM dataset, which is then distilled into a small 58M parameter Llama model which exceeds in performance both of its teacher models as well as a similar model trained without distillation. This suggests that distillation can retain (almost) the full performance of the teacher model when the student model is trained on a sufficiently small dataset. GPT-4 is estimated to run to over a trillion parameters, and GPT-3.5 is around 150 B, while Llama 2 has variants from 7 B to 70 B. Baby Llama is available as a prototype in variants include 15M, 42M and 110M parameters, a huge reduction in size, making this direction for knowledge distillation promising for edge devices.

Knowledge distillation is much more complicated and resource-intensive than quantization, as it requires the training loop to be redone from scratch. Thus, knowledge distillation is more commonly performed by large LLM vendors. However, knowledge distillation may be an attractive option if the goal is to build a smaller AI/ML model that performs well on a subset of a training dataset, to fit a large AI/ML model on a small device, combinations thereof, etc.

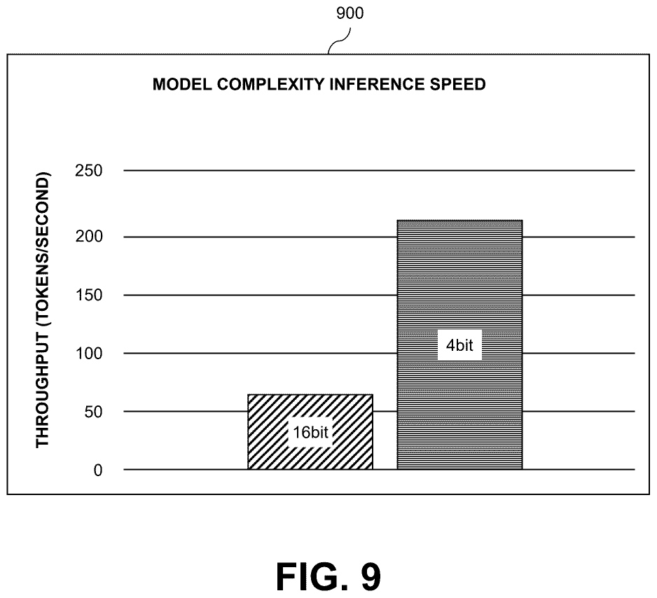

Model compression techniques may also be used to accelerate inference speed, in addition to or in place of decreasing model size. Inference speed may be measured in tokens per second (tokens/sec). Benchmarks on Llama 2 7 B chat and Llama 2 13 B chat models utilizing a 4-bit quantization and FP16 precision, respectively, are shown in the graph 900 of FIG. 9. The graph 900 shows that the 4-bit inference was about 3.16 times faster than FP16 inference (e.g., on an NVIDIA GeForce RTX 4090 GPU). As another example, the Baby Llama prototype has demonstrated approximately 100 tokens/sec rates when running an Apple Macbook Air laptop with the M1 chip.

It should be noted that the AI Everywhere functionality described herein is not limited to any specific model compression methods such as quantization and knowledge distillation. Other model compression approaches, such as pruning, early exiting, dynamic inference and low-rank decomposition can also be used.

Consider, for example, a developer that is interested in testing an AI/ML model and that the developer is about to embark on a business flight. Before takeoff, the developer may connect to the AI Everywhere application and download to their laptop a small instance of the AI/ML model that is to be tested, which is optimized for the hardware specifications of the laptop and the developer's personal preferences (e.g., accuracy, inference speed, etc.), such that the small instance of the AI/ML model can be run offline while on the business flight. If the developer is pleased with the preliminary results obtained by testing the small AI/ML model instance, then upon landing the developer may wish to train and/or perform further testing of a scaled-up instance of the AI/ML model, potentially over a larger dataset, on an AI-optimized corporate server or cloud platform. Model expansion technologies are not readily available, though they may be developed in the future. The AI Everywhere functionality described herein provides a practical alternative to model expansion, as the AI Everywhere application in some embodiments maintains a model repository linking different instantiations of the same AI/ML model using unique identifiers, allowing users to scale AI/ML models up or down for different platforms, and to compare and choose the best AI/ML model instance for their needs and constraints.

The AI Everywhere functionality described herein provides an innovative connecting tissue providing technologic advancements and using hardware and AI/ML model-aware decision and optimization logic to provide AI/ML model mobility between different platforms (e.g., from client to server and storage, from cloud to on-premises/edge and vice versa, etc.). The AI Everywhere functionality provides an entry point for user's AI journeys, facilitating AI/ML solutions across different platforms offered by an enterprise.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated selection and deployment of machine learning model instances to target computing devices will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated selection and deployment of machine learning model instances to target computing devices as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine a machine learning model type to be deployed on a target computing device;
to identify machine learning model performance metrics for operating the determined machine learning model type on the target computing device;
to determine whether any of a set of one or more available instances of the determined machine learning model type (i) have hardware requirements compatible with a hardware configuration of the target computing device and (ii) meet the identified machine learning model performance metrics for operating the determined machine learning model type on the target computing device;
responsive to determining that at least a subset of the set of one or more available instances of the determined machine learning model type (i) have hardware requirements compatible with the hardware configuration of the target computing device and (ii) meet the identified machine learning model performance metrics for operating the determined machine learning model type on the target computing device, to select a given machine learning model instance of the determined machine learning model type from the subset of the set of one or more available instances of the determined machine learning model type; and
to deploy the given machine learning model instance of the determined machine learning model type to the target computing device.

2. The apparatus of claim 1 wherein determining the machine learning model type to be deployed on the target computing device comprises receiving a specification of the determined machine learning model from a user associated with the target computing device.

3. The apparatus of claim 1 wherein determining the machine learning model type to be deployed on the target computing device comprises:
receiving a specification of one or more machine learning tasks to be performed; and
generating a mapping of the one or more machine learning tasks to the determined machine learning model type.

4. The apparatus of claim 1 wherein determining the machine learning model type further comprises selecting one or more repositories of machine learning model instances storing available instances of the determined machine learning model type.

5. The apparatus of claim 1 wherein the machine learning model performance metrics comprise one or more model size constraints.

6. The apparatus of claim 1 wherein the machine learning model performance metrics comprise at least one of a machine learning model accuracy and a machine learning model inference speed.

7. The apparatus of claim 1 wherein the determined machine learning model type comprises a group of two or more versions of a same machine learning model.

8. The apparatus of claim 7 wherein the two or more versions of the same machine learning model utilize different numbers of parameters.

9. The apparatus of claim 1 wherein the at least one processing device is further configured, responsive to determining that none of the set of one or more available instances of the determined machine learning model type (i) have hardware requirements compatible with the hardware configuration of the target computing device and (ii) meet the identified machine learning model performance metrics for operating the determined machine learning model type on the target computing device:
to generate a compressed machine learning model instance of the determined machine learning model type; and
to deploy the generated compressed machine learning model instance of the determined machine learning model type to the target computing device.

10. The apparatus of claim 9 wherein generating the compressed machine learning model instance of the determined machine learning model type comprises performing quantization of at least a portion of one of the set of one or more available instances of the determined machine learning model type from a first precision to a second precision, the second precision being lower than the first precision.

11. The apparatus of claim 10 wherein the first precision comprises a floating point precision with a first number of bits and the second precision comprises a floating point precision with a second number of bits, the second number of bits being less than the first number of bits.

12. The apparatus of claim 10 wherein the first precision comprises a floating point precision with a first number of bits and the second precision comprises an integer precision with a second number of bits, the second number of bits being less than the first number of bits.

13. The apparatus of claim 9 wherein generating the compressed machine learning model instance of the determined machine learning model type comprises performing a variable quantization of two or more portions of one of the set of one or more available instances of the determined machine learning model type between different precision levels.

14. The apparatus of claim 9 wherein generating the compressed machine learning model instance of the determined machine learning model type comprises performing knowledge distillation of at least a portion of one of the set of one or more available instances of the determined machine learning model type utilizing a teacher-student knowledge distillation architecture.

15. A computer program product comprising a non-transitory processor-readable storage medium having stored therein program code of one or more software programs, wherein the program code when executed by at least one processing device causes the at least one processing device:
to determine a machine learning model type to be deployed on a target computing device;
to identify machine learning model performance metrics for operating the determined machine learning model type on the target computing device;
to determine whether any of a set of one or more available instances of the determined machine learning model type (i) have hardware requirements compatible with a hardware configuration of the target computing device and (ii) meet the identified machine learning model performance metrics for operating the determined machine learning model type on the target computing device;
responsive to determining that at least a subset of the set of one or more available instances of the determined machine learning model type (i) have hardware requirements compatible with the hardware configuration of the target computing device and (ii) meet the identified machine learning model performance metrics for operating the determined machine learning model type on the target computing device, to select a given machine learning model instance of the determined machine learning model type from the subset of the set of one or more available instances of the determined machine learning model type; and
to deploy the given machine learning model instance of the determined machine learning model type to the target computing device.

16. The computer program product of claim 15 wherein the program code when executed further causes the at least one processing device, responsive to determining that none of the set of one or more available instances of the determined machine learning model type (i) have hardware requirements compatible with the hardware configuration of the target computing device and (ii) meet the identified machine learning model performance metrics for operating the determined machine learning model type on the target computing device:
to generate a compressed machine learning model instance of the determined machine learning model type; and
to deploy the generated compressed machine learning model instance of the determined machine learning model type to the target computing device.

17. The computer program product of claim 16 wherein generating the compressed machine learning model instance of the determined machine learning model type comprises at least one of:
performing quantization of at least a portion of one of the set of one or more available instances of the determined machine learning model type from a first precision to a second precision, the second precision being lower than the first precision; and
performing knowledge distillation of at least a portion of one of the set of one or more available instances of the determined machine learning model type utilizing a teacher-student knowledge distillation architecture.

18. A method comprising:
determining a machine learning model type to be deployed on a target computing device;
identifying machine learning model performance metrics for operating the determined machine learning model type on the target computing device;
determining whether any of a set of one or more available instances of the determined machine learning model type (i) have hardware requirements compatible with a hardware configuration of the target computing device and (ii) meet the identified machine learning model performance metrics for operating the determined machine learning model type on the target computing device;
responsive to determining that at least a subset of the set of one or more available instances of the determined machine learning model type (i) have hardware requirements compatible with the hardware configuration of the target computing device and (ii) meet the identified machine learning model performance metrics for operating the determined machine learning model type on the target computing device, selecting a given machine learning model instance of the determined machine learning model type from the subset of the set of one or more available instances of the determined machine learning model type; and
deploying the given machine learning model instance of the determined machine learning model type to the target computing device;
wherein the method is performed by at least one processing device comprising a processor coupled to a memory.

19. The method of claim 18 further comprising, responsive to determining that none of the set of one or more available instances of the determined machine learning model type (i) have hardware requirements compatible with the hardware configuration of the target computing device and (ii) meet the identified machine learning model performance metrics for operating the determined machine learning model type on the target computing device:
generating a compressed machine learning model instance of the determined machine learning model type; and
deploying the generated compressed machine learning model instance of the determined machine learning model type to the target computing device.

20. The method of claim 19 wherein generating the compressed machine learning model instance of the determined machine learning model type comprises at least one of:
performing quantization of at least a portion of one of the set of one or more available instances of the determined machine learning model type from a first precision to a second precision, the second precision being lower than the first precision; and
performing knowledge distillation of at least a portion of one of the set of one or more available instances of the determined machine learning model type utilizing a teacher-student knowledge distillation architecture.
